(19) United States
(12) Patent Application Publication
(10) Pub. No.: US 2004/0054561 A1
(43) Pub. Date: Mar. 18, 2004

(54) Vehicle rental managing device, vehicle rental reservation terminal, vehicle rental managing system, and vehicle rental managing method

(76) Inventors: Koichi Ogura, Tokyo (JP); Toshiyasu Watanabe, Asaka-shi (JP); Shuji Yano, Wako-shi (JP); Naoki Terada, Tokorozawa-shi (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/467,167

(22) PCT Filed: Feb. 7, 2002
(86) PCT No.: PCT/JP02/01017

(30) Foreign Application Priority Data
Feb. 15, 2001 (JP) 2001-039003

(51) Int. Cl. G06F 17/60

(52) U.S. Cl. 705/5; 705/1

(57) ABSTRACT

A vehicle rental managing device, a vehicle rental reservation terminal, a vehicle rental managing system, and a vehicle rental managing method for managing vehicles to be lent to users, which are suitable for enhancing the use of vehicles from a port having an excess number to a port having a deficient number of the vehicles in order to eliminate maldistribution of the vehicles. The vehicle rental managing unit includes a vehicle excess-deficiency determination unit which determines an excess or deficient number of the vehicles at the ports by accessing rental circumstances of the vehicles, and a fee setting unit which sets a fee smaller than a normal for a use of the vehicles being lent from a port determined to have an excess number of the vehicles, or for a use of the vehicles to be returned to a port determined to have a deficient number.

### TECHNICAL FIELD

The present invention relates to vehicle rental managing systems, and to vehicle rental managing methods. More specifically, the present invention relates to a vehicle rental managing device, a vehicle rental reservation terminal, a vehicle rental managing system, and a vehicle rental managing method, which are suitable for eliminating problems in allocating vehicles, such as local maldistribution of the vehicles.

This application is based on Japanese Patent Application No. 2001-39003, the contents of which are incorporated herein by reference.

### BACKGROUND ART

In Japanese Unexamined Patent Application, First Publication No. Hei 8-44801, for instance, a technique is disclosed which relates to a shared vehicle managing system in which a communication means is mounted on every one of a plurality of vehicles, which are parked in a parking space (called a port), and the vehicles are managed via a control center based on information which is sent via the communication means so that a plurality of users can share the use of the vehicles parked in the port. In the shared vehicle managing system, information relating to the use of a vehicle is sent to the control center via the communication means when, for instance, a user inserts a recording medium, such as an IC card, in which the ID number of the user is recorded, into a card reader provided with the vehicle. In the control center, transactions, such as approval of renting the vehicle and request of the bill, are carried out based on the received information.

In the shared vehicles managing system described above, a multi-port vehicle managing system is adopted in which the ports are provided at a plurality of places (i.e., multi-port) and a user can fieely travel between the ports using the shared vehicle.

Also, in Japanese Unexamined Patent Application, First Publication No. 2000-30193, for instance, a technique is disclosed which relates to a vehicle allocation system adopted in the multi-port vehicle managing system by which vehicles are stably supplied in accordance with the demand for the vehicles at each port belonging to a group of ports in a certain area. Although the multi-port system is a system having a high degree of flexibility for a user in that the user can drop-off the vehicle at a port located in the vicinity of destination, the system has a drawback in that a temporal maldistribution of vehicles may occur depending on the time the vehicles are used, i.e., for instance, when the vehicles are gathered at a certain port near a restaurant area at lunch time.

In such a case, a user may not rent a vehicle at a certain port because no vehicles are available at the port due to the maldistribution of the vehicles, even though some vehicles are available for use in the entire system. In order to solve this problem, in the technique described in the above publication, expected vehicle demand data is set based on vehicle demand statistical data of all of the ports, and excess and deficiency of vehicles at a certain port is determined by comparing the total of a number of vehicles currently available at each port and an expected number of arriving vehicles from the other ports with a current demanded number of vehicles and expected demand data so that the vehicles are reallocated among the ports by the staff members of the vehicle managing system. In this manner, the vehicles can be stably supplied to the users.

However, in the above-mentioned vehicle allocation system, the efficiency in the system as a whole may be lowered when the staff members spend their time for bringing the vehicles every time that it is required in order to eliminate the problem of maldistribution. Also, since a number of staff members are required to provide a satisfactory service, earnings may be decreased using the vehicle managing system.

### DISCLOSURE OF INVENTION

The present invention takes into consideration the above-mentioned circumstances, and has as an object to provide a vehicle rental managing device, a vehicle rental reservation terminal, a vehicle rental managing system, and a vehicle rental managing method, which are suitable for enhancing the use of vehicles from a port with an excess thereof to a port with a deficiency thereof in order to eliminate maldistribution of the vehicles.

In order to achieve the above object, a first aspect of the present invention provides a vehicle rental managing unit (for instance the reservation control center 1 in an embodiment described later), which is used in a vehicle rental managing system for managing vehicles to be lent to users by providing a plurality of ports used for parking the vehicles, including a vehicle excess-deficiency determination unit (for instance, steps S11-S20 in the embodiment described later) which determines an excess number or deficient number of the vehicles at each of the ports by accessing rental circumstances of the vehicles at the ports, and a fee setting unit (for instance, steps S21-S27 in the embodiment described later) which sets a fee smaller than a normal fee for a use of the vehicles being lent from a port determined to have an excess number of the vehicles by the vehicle excess-deficiency determination unit, or for a use of the vehicles to be returned to a port determined to have a deficient number of the vehicles by the vehicle excess-deficiency determination unit.

According to the vehicle rental managing unit described above, it becomes possible to grasp the maldistribution circumstances of the vehicles among the ports, and to enhance the use of the vehicles in directions eliminating the maldistribution of the vehicles by setting lower fees than normal for such destinations.

The present invention also provides a vehicle rental reservation terminal (for instance, the mobile phone 3 in the embodiment described later), which is used in a vehicle rental managing system for managing vehicles to be lent to users by providing a plurality of ports used for parking the vehicles, including a conditions display unit (for instance, step S63 in the embodiment described below) which receives and displays information relating to rental circumstances of the vehicles at each of the ports, and a port selection unit for instance, step S64 in the embodiment described below) which makes the users choose a port for use based on the vehicle rental circumstances at each of the ports displayed by the conditions display unit.

In another aspect of the present invention, the conditions display unit displays the information relating to rental circumstances of the vehicles at each of the ports in a manner distinguishing the ports having an excess number or a deficient number of vehicles from the other ports.

According to the vehicle rental reservation terminal described above, it becomes possible to notify the users of the maldistribution circumstances of the vehicles among the ports, and make the users determine the destinations of vehicles can be utilized at lower costs.

The present invention also provides a vehicle rental managing system for managing vehicles to be lent to users by providing a plurality of ports used for parking the vehicles including a vehicle excess-deficiency determination unit which determines an excess number or deficient number of the vehicles at each of the ports by accessing rental circumstances of the vehicles at the ports, a fee setting unit which sets a fee smaller than a normal fee for a use of the vehicles being lent from a port determined to have an excess number of the vehicles by the vehicle excess-deficiency determination unit, and for use of the vehicles to be returned to a port determined to have a deficient number of the vehicles by the vehicle excess-deficiency determination unit: a conditions display unit which displays information relating to rental distributions of the vehicles at each of the ports, the information being received from the vehicle excess-deficiency determination unit, and a port selection unit which makes the users choose a port of use based on the vehicle rental distributions at each of the ports displayed by the conditions display unit.

In yet another aspect of the present invention, the conditions display unit displays the information relating to rental distributions of the vehicles at each of the ports in a manner distinguishing the ports with an excess number or a deficient number of the vehicles from the other ports so that the users can determine routes of the vehicles, fees of which are set to be smaller than the normal fees by the fee setting unit.

The present invention also provides a vehicle rental managing method, which is used in a vehicle rental managing system for managing vehicles to be lent to users by providing a plurality of ports used for parking the vehicles including a vehicle excess-deficiency determination step in which an excess number or deficient number of the vehicles at each of the ports is determined by accessing rental information of the vehicles at the ports; a fee setting step in which a fee smaller than a normal fee is set for a use of the vehicles being lent from a port determined to have an excess number of the vehicles by the vehicle excess-deficiency determination step, or for a use of the vehicles to be returned to a port determined to have a deficient number of the vehicles in the vehicle excess-deficiency determination step; a conditions display step in which information relating to rental distributions of the vehicles at each of the ports is displayed, the information being received from the vehicle excess-deficiency determination step; a port selection acquiring step in which information relating to a port of use selected by the user based on the vehicle rental information displayed in the conditions display step is acquired, and a vehicle rental step in which a vehicle is lent to the user at the port selected by the user in the port selection acquiring step at the fee determined in the fee setting step.

In yet another aspect of the present invention, the information relating to rental circumstances of the vehicles at each of the ports is displayed in a manner distinguishing the ports with an excess number or a deficient number of the vehicles from the other ports in the conditions display step so that the users can determine routes of the vehicles, fees of which are set to be smaller than the normal fees by the fee setting step.

In yet another aspect of the present invention, the information relating to the rental circumstances of the vehicles at each of the ports is displayed on a terminal of the user in the conditions display step, and the information relating to the port of use selected by the user is acquired through the terminal of the user in the port selection acquiring step.

In yet another aspect of the present invention, the information relating to rental information of the vehicles at each of the ports is displayed on a terminal of the user, the Internet, or a bulletin board provided at the ports in the conditions display step.

### BRIEF DESCRIPTION OF DRAWINGS

Some of the features and advantages of the invention having been described, others will become apparent from the detailed description which follows, and from the accompanying drawings in which:

FIG. 1 is a schematic diagram showing a configuration of an embodiment according to the present invention;

FIG. 2 is a schematic diagram showing a construction of a shared vehicle used in the embodiment according to the present invention;

FIGS. 3A and 3B are diagrams showing an interior and an exterior, respectively, of the shared vehicle used in the embodiment of the present invention;

FIGS. 4A and 4B are diagrams showing maldistribution of the shared vehicles in a vehicle rental managing system according to the embodiment of the present invention;

FIG. 5 is a flowchart for explaining a vehicle managing operation by a reservation control center of the vehicle rental managing system according to the embodiment of the present invention:

FIG. 6 is a flowchart for explaining the vehicle managing operation, in particular, a port condition screen producing operation, by the reservation control center of the vehicle rental managing system according to the embodiment of the present invention;

FIG. 7 is a flowchart for explaining the vehicle managing operation, in particular, an initial charging operation, by the reservation control center of the vehicle rental managing system according to the embodiment of the present invention;

FIG. 8 is a table showing an example of the charging system used in the vehicle rental managing system according to the embodiment of the present invention when maldistribution of the shared vehicles occurs;

FIG. 9 is a flowchart for explaining the vehicle managing operation, in particular, a vehicle reallocation process, by the reservation control center of the vehicle rental managing system according to the embodiment of the present invention;

FIG. 10 is a flowchart for explaining the flow of the entire processes in the vehicle rental managing system according to the embodiment of the present invention,

FIG. 11 is a chart showing a reservation procedure for the shared vehicle, in particular, an authentication process, carried out between the user and the reservation control center including the operations performed by the user;

FIG. 12 is a chart showing the reservation procedure for the shared vehicle, in particular, a reservation acceptance process, carried out between the user and the reservation control center including the operations performed by the user;

FIG. 13 is a chart showing the reservation procedure for the shared vehicle, in particular, a vehicle deficiency corresponding process, carried out between the user and the reservation control center including the operations performed by the user;

FIG. 14 is a chart showing the reservation procedure for the shared vehicle, in particular, a reservation confirmation process, carried out between the user and the reservation control center including the operations performed by the user; and

FIG. 15 is a diagram showing a display of a mobile phone during a reservation process in the vehicle rental managing system according to the embodiment of the present invention.

### BEST MODE FOR CARRYING OUT THE INVENTION

Hereinafter, embodiments of the present invention will be described with reference to the attached drawings.

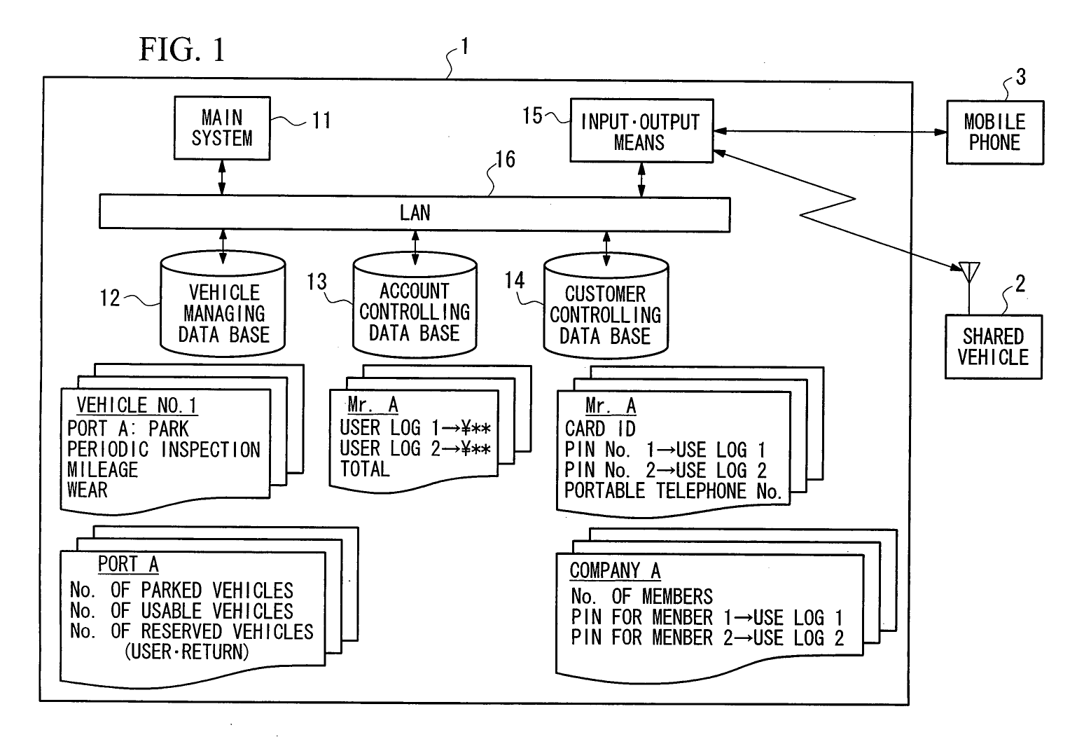

FIG. 1 is a block diagram showing a configuration of an embodiment according to the present invention.

In FIG. 1, a reservation control center 1 is a center for controlling a shared use of vehicle 2 by users, and controls such items as a reservation, dispatch, and bill request relating to the vehicles 2. A mobile phone 3 is owned by a user and the number thereof is recorded in the reservation control center 1 when the user is registered as a member. Note that one or more of the vehicles 2 are controlled under the reservation control center 1.

The mobile phone 3 includes one using the personal handy phone system (PHS), and is an example of the rental reservation terminal of a wireless communication terminal that is capable of supplying information to the user as well as informing the operation of the user to the reservation control center 1 by wireless communication. Note that any device may be used as the rental reservation terminal as long as the device enables communication with the reservation control center 1 independently. Accordingly, although it is preferable that the rental reservation terminal including the mobile phone 3 be connected to a public network, wireless communication terminals owned by a company, etc., may be rented to the members of the vehicle rental managing system. Also, the rental reservation terminal need not be a wireless communication terminal and may be a cable communication terminal, which can be connected to a public network via wire (cable).

Also, the reservation control center 1 includes a main system 11, a vehicle managing database 12, an account controlling database 13, a customer controlling database 14, an input/output means 15, and a local area network (LAN) 16.

The main system 11 performs a reservation control center controlling program in a computer system provided with a central processing unit (CPU) in order to control the entire operation of the reservation control center 1. The operation of the main system 11 will be described in detail later.

The vehicle managing database 12 is a database in which states of each of the shared vehicles and ports are recorded in order to manage the shared vehicles 2. Items that may be recorded in the vehicle managing database 12 include, for example:

(1) location;

(2) time for periodic inspection;

(3) mileage, and

(4) degree of wear of each part, of each shared vehicle, and

(1) number of currently parked vehicles;

(2) number of currently usable vehicles, and

(3) number of reserved vehicles (use, return), at each port.

The account controlling database 13 is a database in which a charging system used for calculating the fee for travelling between ports by shared vehicles and log files carrying bills for each user to settle the fee via a credit company are recorded. For example, in the account controlling database 13, fees for using the shared vehicle 2 based on combinations of the ports and moving directions, a plurality of log files in which a fee for using a vehicle is recorded for every use, and which are separated for each billing address, such as one account of a plurality of financial institutions, or a plurality of accounts of one financial institution, and a total of the fee are recorded.

The customer controlling database 14 is a database in which data of each user registered as a member is recorded. In the customer controlling database 14, for the cases where a member is an individual member, items may be recorded, such as:

(1) a card ID for authenticating a card;

(2) a plurality of personal identification numbers (PIN), such as PIN No. 1 and PIN No. 2, having different logs to which they are related, and

(3) a portable telephone number of the member.

Also, for the cases where a member is a corporate member, items may be recorded in the customer controlling database 14, such as:

(1) number of contracts with corporate members, and

(2) a plurality of PINs, such as PIN for corporate member No. 1 and PIN for corporate member No. 2, having different logs to which they are related.

The input/output means 15 is an interface unit used by the reservation controlling center 1 for sending and receiving reservation data, availability data, etc., of the shared vehicle 2 to/from the mobile phones 3 of the users. The input/output means 15 may also be used as an interface unit for sending and receiving vehicle managing data between the reservation controlling center 1 and the shared vehicles 2. Note that the vehicle managing data may be sent and received between the reservation controlling center 1 and the shared vehicles 2 by means of radiocommunication via a communication device (not shown in the figure) provided for each port.

The LAN 16 is a communication network which forms a local area network for sending and receiving data by connecting the above-mentioned main system 11, the vehicle managing database 12, the account controlling database 13, the customer controlling database 14, and the input/output means 15 in the reservation controlling center 1.

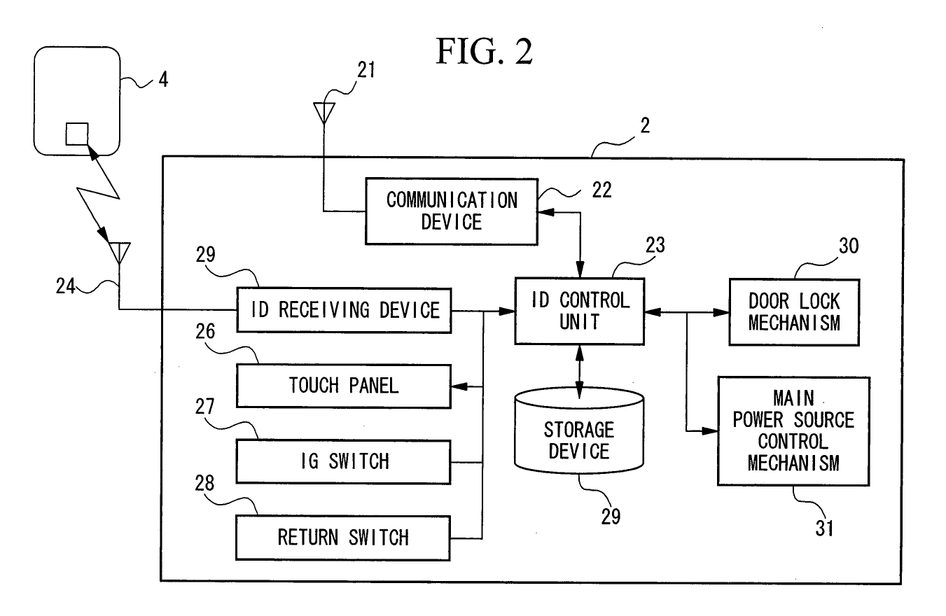

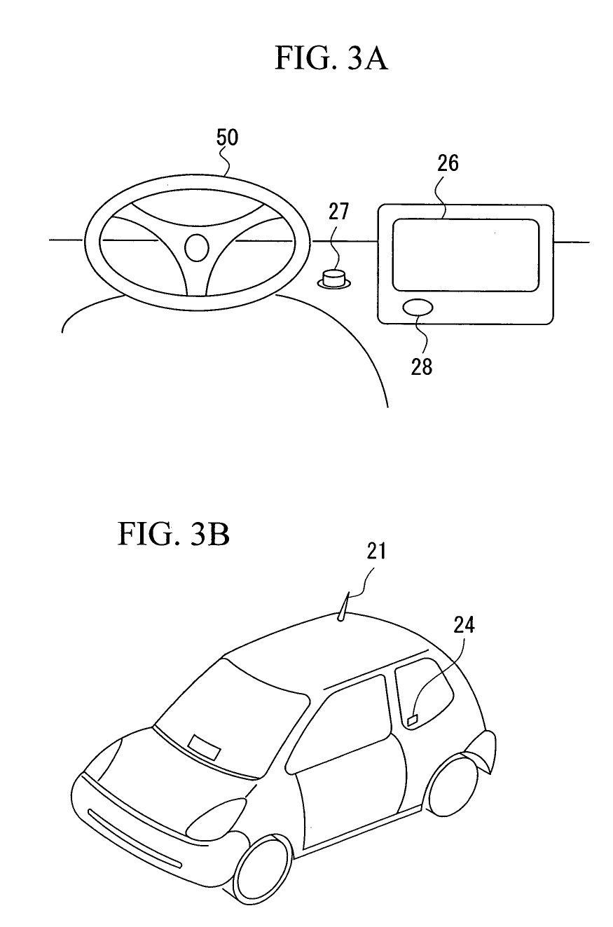

Next, the shared vehicle 2 used in an embodiment according to the present invention will be described in detail with reference to FIGS. 2 and 3.

FIG. 2 is a block diagram showing a configuration of the shared vehicle 2. In FIG. 2, the shared vehicle 2 includes a communication antenna 21, a communication device 22, an ID control unit 23, a door antenna 24, an ID receiving device 25, a touch panel 26, an ignition (IG) switch 27, a return switch 28, a storage device 29, a door lock mechanism 30, and a main power source controlling mechanism 31.

The shared vehicle 2 is parked at a parking space called a port. Various kinds of data may be exchanged between the shared vehicle 2 and the reservation control center 1 by means of radiocommunication using a communication instrument (not shown in the figure) provided at each of the ports via the communication device 22 connected to the communication antenna 21 of the shared vehicle 2.

When a user holds, for instance, a non-contact read and write type IC card 4 to the door antenna 24 provided with the shared vehicle 2, a signal read by the ID receiving device 25 is transmitted to the ID control unit 23 which controls the ID number of the shared vehicle 2. The ID control unit 23 communicates with the communication instrument (not shown in the figure) provided at each of the ports by means of radiocommunication via the communication device 22 connected to the communication antenna 21 in order to transmits the order from the user to use the shared vehicle 2 using the IC card 4 to the reservation control center 1 and asks for permission to use the vehicle 2.

Note that the above-mentioned IC card 4 is an example of an ID terminal which is capable of reading and writing recorded ID numbers, and according to this embodiment of the present invention, the ID terminal used for informing the ID number to the vehicle 2 is not limited, if the reading device of the vehicle 2 side can cope with the ID terminal, to the non-contact read and write type card and any form thereof is acceptable as long as it is capable of reading and writing a recorded ID number, such as, other than an IC card, a magnetic card and a mobile phone including an internal IC.

Also, when the user rents the vehicle 2, the user inputs required information to the ID control unit 23 via the touch panel 26, and starts using the vehicle 2 by pushing the ignition (IG) switch 27 to turn on the ignition of the vehicle 2. In addition, when the user returns the vehicle 2 to a particular port, the user is required to carry out a return process by pushing the return switch 28 at the port.

Furthermore, an ID number assigned for every one of the shared vehicles 2 is prestored in the storage device 29. Also, an ID number or a PIN input by a user is temporarily stored in the storage device 29. The ID control unit 23 transmits the ID number of the vehicle 2 stored in the storage device 29, and the ID number or the PIN input by the user to the reservation control center 1, and when permission is given to the user to rent the vehicle 2, the door lock mechanism 30 unlocks the door key by a command from the reservation control center 1 to which permission for renting the vehicle was requested, and the main power source control mechanism 31 permits the use of the ignition circuit.

FIGS. 3A and 3B are diagrams showing an interior and an exterior of the shared vehicle 2, respectively. FIG. 3A shows an interior of the shared vehicle 2 in the vicinity of the driver's seat, and FIG. 3B shows the exterior of the vehicle 2 shown in FIG. 3A.

In FIG. 3A, the IG switch 27 is disposed in the vicinity of a steering wheel 50, and the touch panel 26 is disposed at a position where it does not interfere with the front view of the driver. Also, the return switch 28, which is used when the vehicle 2 is returned to a port, is disposed at the lower side of the touch panel 26.

In FIG. 3B, the communication antenna 21 is disposed on the roof of the shared vehicle 2 so that radio signals may be received from all directions, and the door antenna 24 is disposed on the door glass in the vicinity of the driver's seat (i.e., the left side of the vehicle 2 in this case).

Next, maldistribution of the shared vehicles 2 which may be generated in the vehicle rental managing system including a plurality of ports for parking the vehicles 2 will be explained.

The term “maldistribution of vehicles” means a phenomenon in which a majority of vehicles are temporally parked at a certain port (i.e., in which the distribution is unbalanced) when the vehicles should instead be parked evenly at a plurality of ports, due to arbitrary use of the vehicles 2 by the users. The generation of maldistribution may be determined as follows.

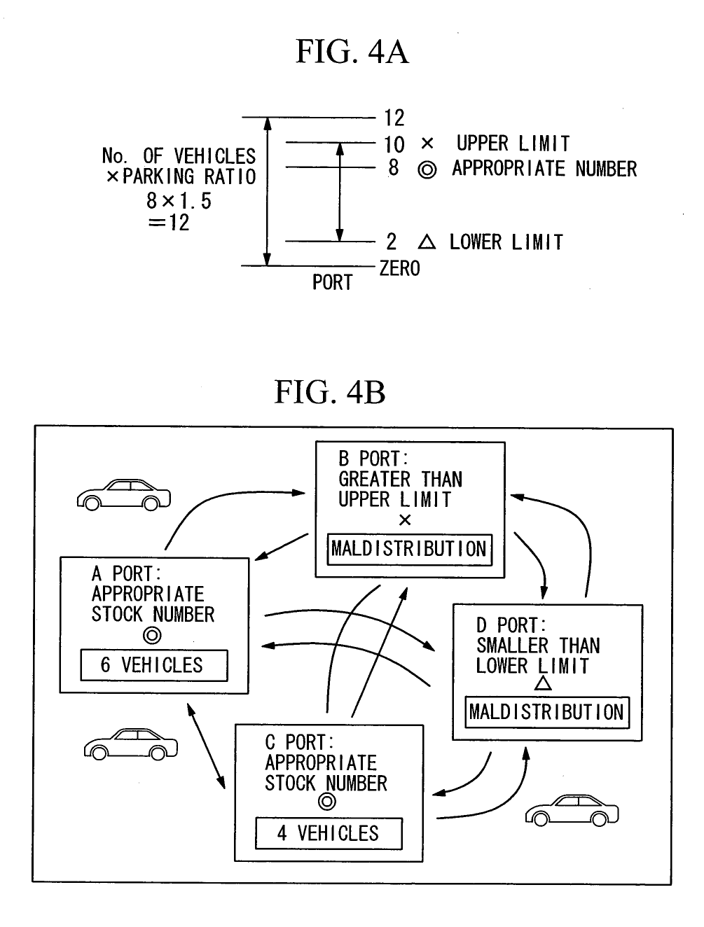

Suppose the maximum number of vehicles can be parked at a port is 12, as shown in FIG. 4A, and it is assumed that the suitable number of the vehicles parked at the port should be 8, which is obtained by dividing the maximum number, 12, by a parking ratio of 1.5. In this case, the upper limit of the number of the vehicles parked at the port is estimated to be 10, which is obtained by adding 2, which assures adequate provision of the vehicles, to the suitable number of 8. Also, the lower limit of the number of the vehicles parked at the port is estimated to be 2, which assures adequate provision of the vehicles as mentioned above with respect to the case where no vehicles are available at the port. If the number of the vehicles parked at the port is in the range between the upper limit and the lower limit described above, it is determined that the port has an appropriate number of available vehicles.

The number of the shared vehicles 2 parked at each port is evaluated in the manner described above, and as shown in FIG. 4B, when the number of the vehicles parked at the ports A-D, respectively, is as follows:

(1) A port: 6 parked vehicles which is in the range of the appropriate available number;

(2) B port: maldistribution generated being greater than the upper limit of the parked vehicles;

(3) C port: 4 parked vehicles, which is in the range of an appropriate available number; and

(4) D port: maldistribution generated being less than the lower limit of the parked vehicles,

the above ports A-D may be distinguished as follows according to this embodiment of the present invention:

(1) port A: ⊚

(2) port B: X.

(3) port C: ⊚ and

(4) port D: Δ.

Next, the vehicle managing operation by the reservation control center 1 in the vehicle rental managing system with the purpose of avoiding the occurrence of the above-mentioned maldistribution of the vehicles will be explained with reference to the drawings.

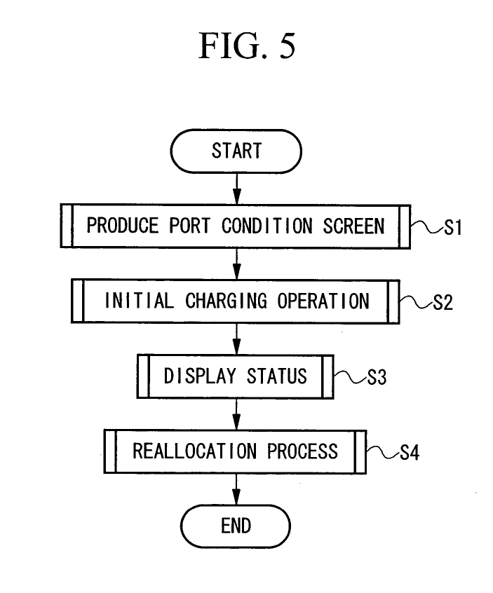

FIG. 5 is a flowchart for explaining the entire vehicle managing operation by the reservation control center 1. First, the main system 11 of the reservation control center 1 checks the condition of each port, such as the number of shared vehicles 2 parked at the port, and produces a port condition screen for displaying the use condition at each port for, for instance, the mobile phone 3 owned by a user when the user makes reservation of the shared vehicle 2 using the mobile phone 3 (step S1).

The reservation control center 1, when it ascertains the situation of each port, carries out an initial charging operation, by which fees for using the shared vehicle 2 between the ports are determined based on the use condition at each port so that the user can use the shared vehicle 2 at low cost if the user travels in a direction avoiding the generation of maldistribution of the vehicles (step S2).

The above-mentioned condition of the ports and fees between the ports may be confirmed by the user all the time by displaying them on the mobile phone 3 of the user, the Internet which may be accessed from a terminal, or an electronic bulletin board disposed at a port when the user makes reservation (step S3).

Also, if the maldistribution of the vehicles at the ports is not resolved even by setting a lower charge to enhance the use of the shared vehicles 2 as mentioned above, the vehicles 2 are reallocated among the ports by the staff members of the vehicle managing system (step S4).

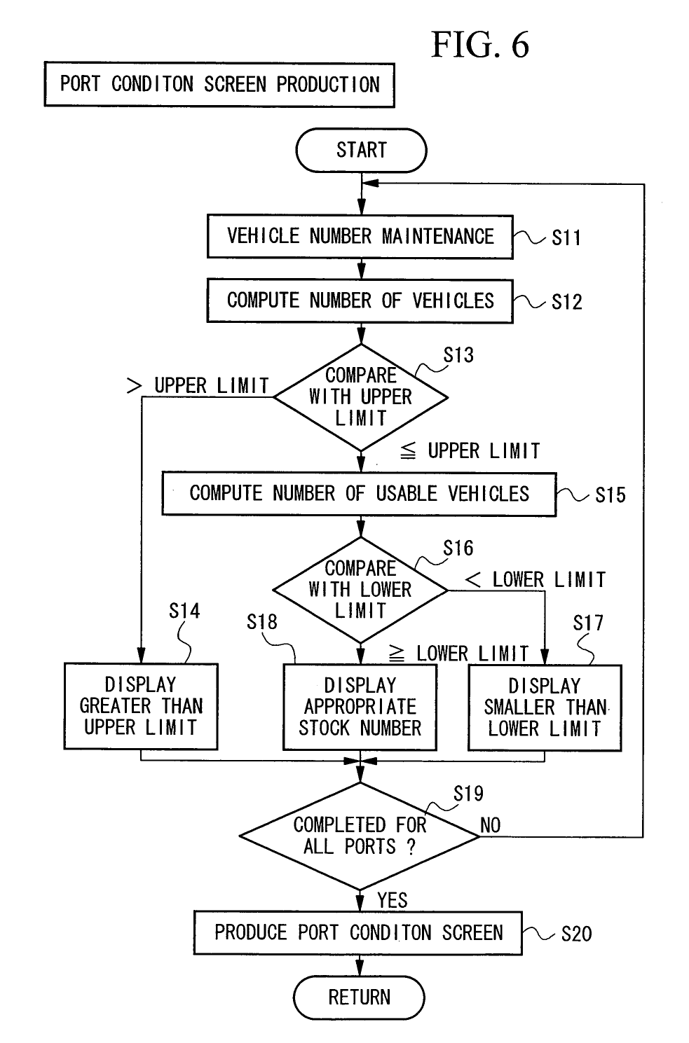

Next, each step of the above-mentioned operation will be explained in detail with reference to FIG. 6.

FIG. 6 is a flowchart for explaining the vehicle managing operation of the reservation control center 1. In FIG. 6, the operation of producing the port condition screen, in particular, is explained in detail.

First, the main system 11 of the reservation control center 1 computes the number of currently parked vehicles and the number of usable vehicles, which may be determined by subtracting the number of vehicles under maintenance from the number of currently parked vehicles, based on the state of the vehicles parked at a port, and carries out a maintenance of the number of vehicles parked at each of the ports (step S11).

Then, the main system 11 of the reservation control center 1 computes the number of vehicles to be parked at a port by adding the number of vehicles scheduled to be returned to the port to the number of the currently parked vehicles at the port (step S12).

When the number of vehicles to be parked is obtained, it is determined whether the number of vehicles to be parked exceeds the upper limit of the number of parked vehicles at the port (which is explained above) with reference to FIG. 4A (step S13).

In step S13, if the number of vehicles to be parked exceeds the upper limit of the number of parked vehicles at the port (i.e., >the upper limit in step S13 in FIG. 6), this is displayed by using the display signal indicating the maldistribution explained above with reference to FIG. 4B (step S14).

If the number of vehicles to be parked does not exceed the upper limit of the number of parked vehicles at the port (i.e., ≦the upper limit in step S13 in FIG. 6), on the other hand, the main system 11 of the reservation control center 1 computes the number of usable vehicles by adding the number of reserved vehicles to the number of currently usable vehicles (step S15).

When the number of usable vehicles is obtained, it is determined whether this number of usable vehicles is lower than the lower limit of the number of parked vehicles at the port which is explained above with reference to FIG. 4A (step S16).

In step S16, if it is determined that the number of usable vehicles is less than the lower limit of the number of parked vehicles (i.e., <the lower limit in step S16 in FIG. 6). this is displayed by using the display signal indicating the maldistribution explained above with reference to FIG. 4B (step S17).

If it is determined that the number of usable vehicles is not less than the lower limit of the number of parked vehicles at the port (i.e., ≧the lower limit in step S16 in FIG. 6), on the other hand, this is displayed by using the display signal indicating the appropriate available number explained above with reference to FIG. 4B (step S18).

After the indication of maldistribution (being greater than the upper limit or lower than the lower limit) or of the appropriate available number is completed for each port, the reservation control center 1 determines whether the display setting is completed for all of the ports (step S19). If the display setting is not completed for all of the ports, the process returns to step S11 to repeat the above-mentioned operation.

If it is determined that the process is completed for all of the ports in step S19 (i.e., YES in step S19), on the other hand, a port condition screen is produced (step S20) to be displayed on the mobile phone 3 of the user when the user makes a reservation, on the Internet which may be accessed from a terminal, or on an electronic bulletin board disposed at a port. Then, the process returns to the main routine shown in FIG. 5 to carry out the next initial charging operation process.

Note that the display signals used in the above-mentioned display setting are mere examples, and any display signals may be utilized as long as the user can recognize the condition of the ports.

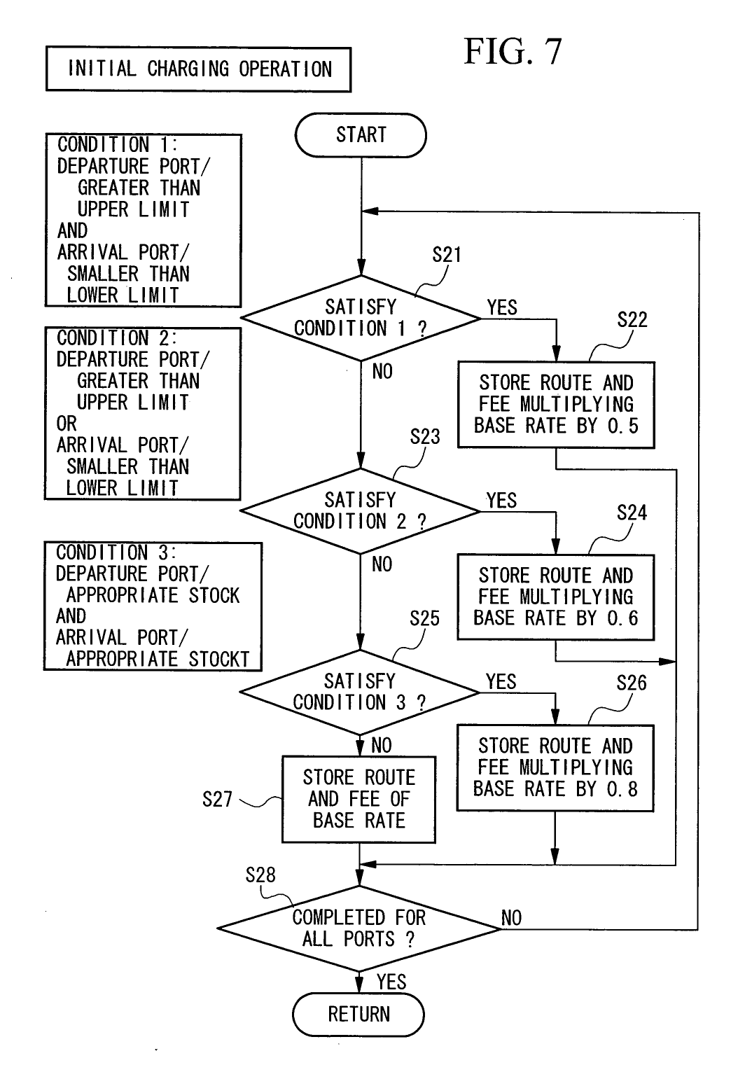

FIG. 7 is a flowchart showing the vehicle managing operation by the reservation control center 1. In FIG. 7, the initial charging operation, in particular, is explained in detail.

First, the main system 11 of the reservation control center 1 determines whether the number of parked vehicles at the ports of a certain combination satisfies the condition 1 (i.e., the departure port: greater than the upper limit AND the arrival port: less than the lower limit) (step S21).

In step S21, if the combination of the ports satisfy the condition 1 (i.e., YES in step S21 in FIG. 7), the fee between the ports is calculated by multiplying the base rate by, for instance, 0.5, and the route and the fee thereof are stored in the account controlling data base 13 (step S22).

In step S21, if the combination of the ports does not satisfy the condition 1 (i.e., NO in step S21 in FIG. 7), the reservation control center 1 determines whether the number of parked vehicles at the ports of the combination satisfies the condition 2 (i.e., the departure port: greater than the upper limit OR the arrival port: less than the lower limit) (step S23).

In step S23, if the combination of the ports satisfy the condition 2 (i.e., YES in step S23 in FIG. 7), the fee between the ports is calculated by multiplying the base rate by, for instance, 0.6, and the route and the fee thereof are stored in the account controlling data base 13 (step S24).

In step S23, if the combination of the ports does not satisfy the condition 2 (i.e., NO in step S23 in FIG. 7), the reservation control center 1 determines whether the number of parked vehicles at the ports of the combination satisfies the condition 3 (i.e., the departure port: appropriate available number AND the arrival port: appropriate available number) (step S25).

In step S25, if the combination of the ports satisfy the condition 3 (i.e., YES in step S25 in FIG. 7), fee between the ports is calculated by multiplying the base rate by, for instance, 0.8, and the route and the fee thereof are stored in the account controlling data base 13 (step S26).

In step S25, if the combination of the ports does not satisfy the condition 3 (i.e., NO in step S25 in FIG. 7), on the other hand, the reservation control center 1 applies the base rate for the combination of the ports, and the route and the fee thereof are stored in the account controlling data base 13 (step S27).

When the fee setting process for the combinations of the ports is completed, it is determined whether the process is carried out for all of the combinations of the ports (step S28). If the process is not carried out for all of the combinations of the ports (i.e., NO in step S28 in FIG. 7), the process returns to step S21, and the above-mentioned operation is repeated for the next combination of the ports.

If it is determined that the process is carried out for all of the combinations of the ports (i.e., YES in step S28 in FIG. 7), on the other hand, the initial charging operation is completed and returns to the main routine shown in FIG. 5 to carry out the status display operation.

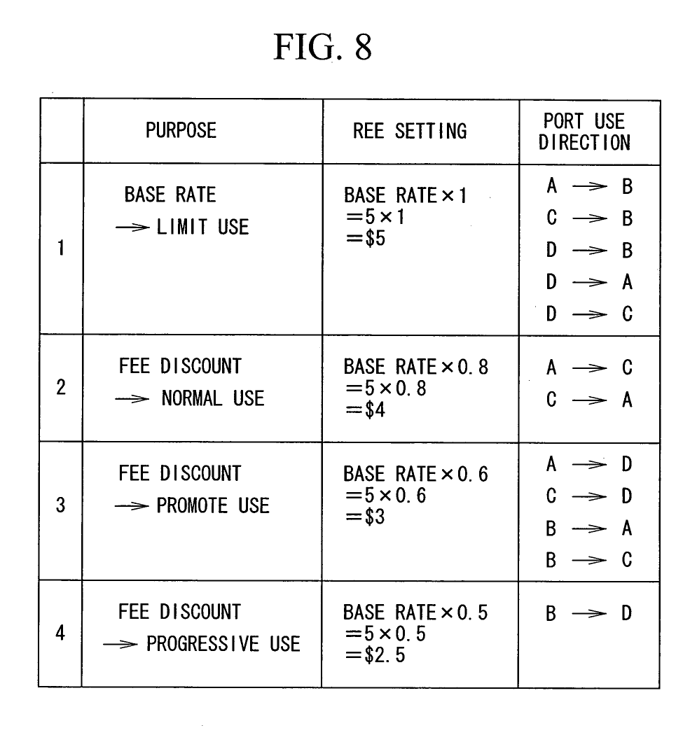

FIG. 8 is a table showing an example of the charging system stored in the account controlling data base 13 in which fees are determined based on the initial charging operation shown in the flowchart of FIG. 7 with respect to the example of the maldistribution of the shared vehicles 2 among the ports A-D shown in FIG. 4B.

In FIG. 8, four charging patterns, which are explained below, are shown. The charging patterns are set in order to control the use of vehicles by the users and enhance the use of vehicles in directions to resolve the maldistribution of the vehicles, that is:

(1) fee between the ports is set to be a basic fee of, for instance, $5, with the purpose of limiting (discouraging) the use of shared vehicles 2 (this may apply to the use of the vehicle 2 to return to the port with excess vehicles, or the lending of the vehicle 2 from the port lacking vehicles),

e.g., A→B, C→B, D→B, D→A, and D→C;

(2) fee between the ports is set to be, for instance, base rate×0.8=$4 with the purpose of encouraging normal use (this may apply to the use of the vehicle 2 between the ports having appropriate available numbers of vehicles 2),

e.g., A→C, and C→A;

(3) fee between the ports is set to be, for instance, base rate×0.6=$3 with the purpose of enhancing the use of shared vehicles 2 (this may apply to the use of the vehicle 2 to lend from the port with excess vehicles, or the returning of the vehicle 2 to the port lacking vehicles),

e.g., A→D, C→D, B→A, and B→C; and

(4) fee between the ports is set to be, for instance, base rate×0.5=$2.5 with the purpose of progressive use of the shared vehicles 2 by users (this may apply to the use of the vehicle 2 to lend from the port with excess vehicles, and the returning of the vehicle 2 to the port lacking vehicles).

e.g., B→D.

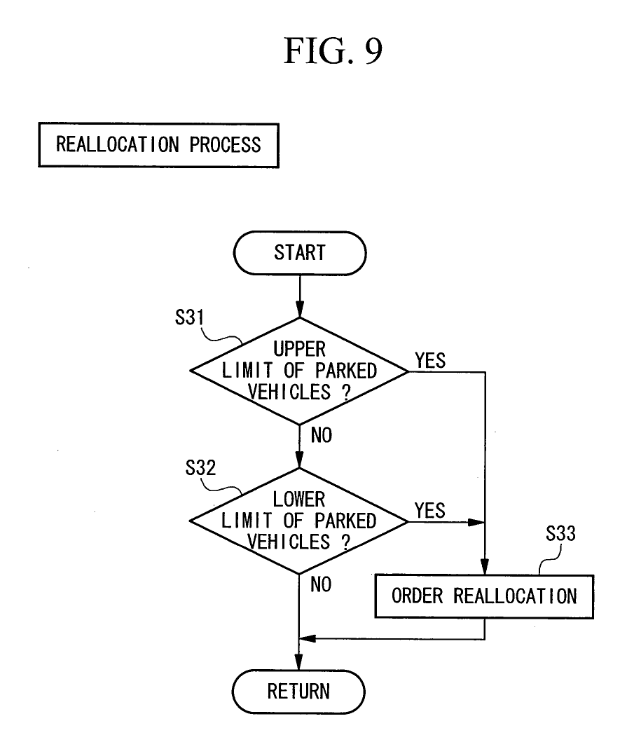

FIG. 9 is a flowchart for explaining the vehicle managing operation by the reservation controlling center 1. In FIG. 9, the vehicle reallocation process, in particular, is explained in detail.

If the maldistribution of the vehicles 2 among the ports is not resolved by using the charging system shown in FIG. 8, the main system 11 of the reservation control center 1 determines whether there is a port at which the number of the shared vehicles 2 parked is at the upper limit of the number of parked vehicles (i.e., a port at which the maximum number of shared vehicles 2 are parked) (step S31) and whether there is a port at which the number of the usable vehicles among the parked shared vehicles 2 is the lower limit (i.e., the number of shared vehicles 2 that can be used is zero) (step S32), and carries out a reallocation process of the vehicles by the staff members of the vehicle rental managing system (step S33) for the port at which the number of the shared vehicles 2 is the upper limit of the number of parked vehicles (i.e., YES in step S31 in FIG. 9) and for the port at which the number of the usable vehicles among the parked shared vehicles 2 is the lower limit (i.e., YES in step S32 in FIG. 9). Then, the process returns to the main routine shown in FIG. 5.

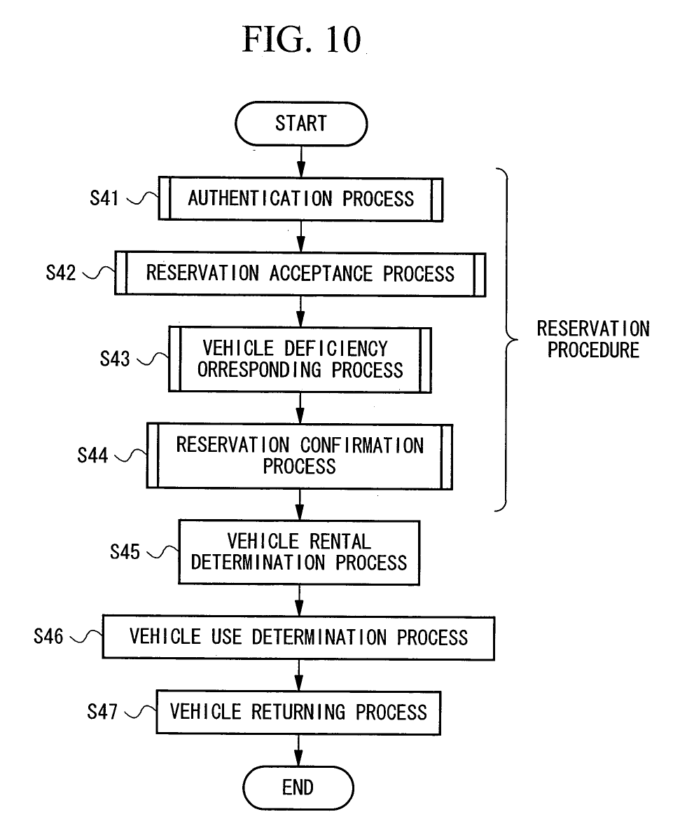

Next, the operation of the above-mentioned vehicle rental managing system and the use thereof will be explained with reference to the drawings. FIG. 10 is a flowchart for explaining the flow of the entire processes in the vehicle rental managing system.

When the user accesses to the reservation control center 1 using the mobile phone 3 owned by the user, the main system 11 of the reservation control center 1 carries out an authentication process to determine whether the user is a registered member (step S41).

If it is determined that the user is indeed a registered member, the main system 11 of the reservation control center 1 performs a reservation acceptance process by making the user input desired use conditions of the shared vehicle 2, such as the ports of departure and arrival, and the expected day of use and hours (step S42).

Then, the reservation control center 1 determines whether it can satisfy the desired conditions set by the user in the reservation acceptance process. If it is determined that the conditions set by the user cannot be met, the main system 11 of the reservation control center 1 carries out a vehicle deficiency corresponding process in which the user is again requested to input another desired use conditions (step S43).

After the completion of a reservation confirmation process in which the use conditions are finally determined by the user (step S44), the main system 11 carries out the “reservation procedure” of steps S41 through S44.

When the reservation procedure is completed and the right of using the shared vehicle 2 is secured, the user actually goes to the port at which the reserved shared vehicle 2 is parked and presents the card ID of the user by holding the IC card 4 to the shared vehicle 2 the user wishes to use. The shared vehicle 2 to which the user card ID is presented carries out a vehicle rental determination process by communicating with the reservation control center 1 to determine whether the user can enter (access) the inside of the shared vehicle 2 (step S45).

If the user is allowed to enter the shared vehicle 2, the user inputs a desired PIN if the user is an individual member, or an assigned PIN if the user is a corporate member, through the touch panel 25 so that the shared vehicle 2 may carry out a vehicle use determination process by communicating with the reservation controlling center 1 (step S46).

Finally, when the user, who has been allowed to use the shared vehicle 2 through the vehicle use determination process, has completed the use of the vehicle 2 and returns the vehicle 2, the user carries out a vehicle returning process to return the vehicle 2 to a port (step S47). In this manner, the operation for lending the shared vehicle 2 in the vehicle managing system according to the embodiment of the present invention is completed.

Note that when the user carries out the vehicle returning process, the fee is calculated based on the charging system stored in the account controlling database 13 shown in FIG. 8 and recorded in the user's log files stored in the account controlling database 13. Then, the fee is charged to an account assigned for each of the log files via a credit company assigned beforehand.

Next, the above mentioned reservation procedure will be explained in detail with reference to the attached drawings.

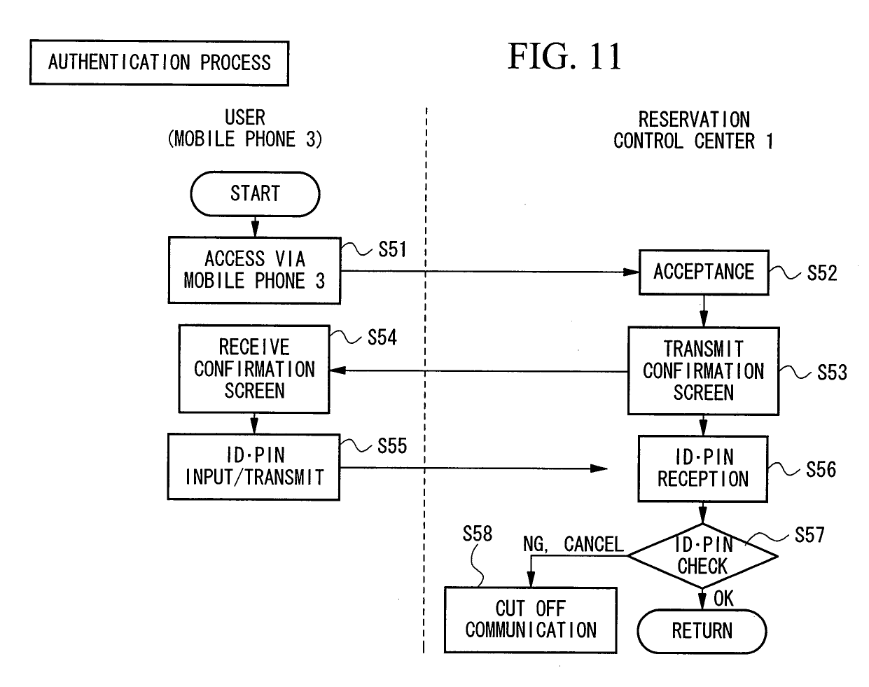

FIG. 11 is a chart showing the reservation procedure for the shared vehicle 2 carried out between the user (mobile phone 3) and the reservation control center 1 including the operations performed by the user. In FIG. 11, the authentication process, in particular, is described in detail.

When the user makes access to the reservation control center 1 by using the mobile phone 3 owned by the user (step S51), the reservation control center 1 accepts the access (step S52) and transmits the confirmation screen to the mobile phone 3 (step S53).

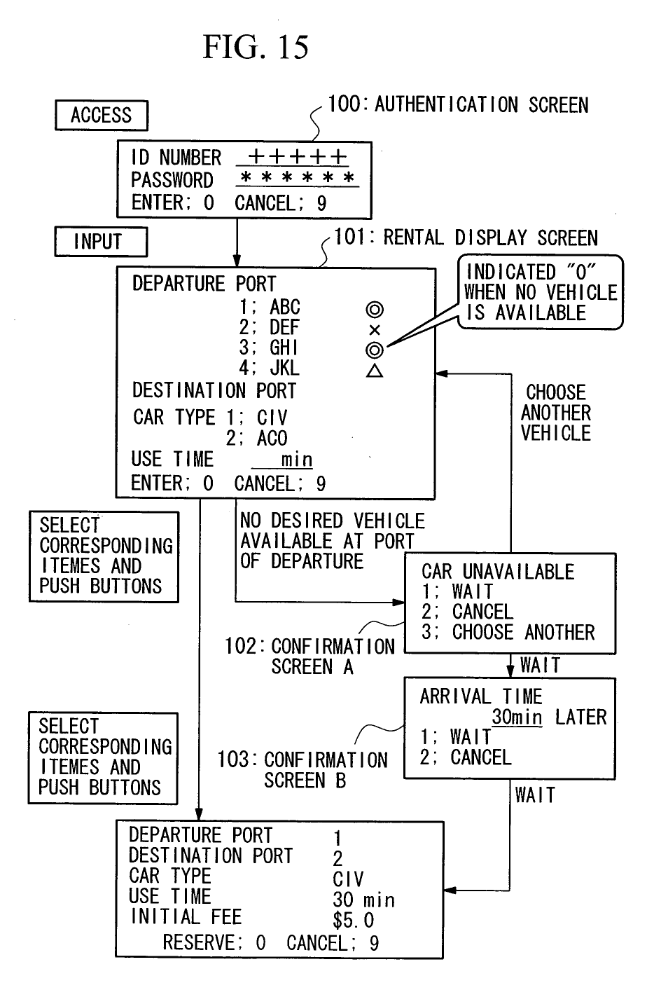

The confirmation screen which appears in the authentication process may be the authentication screen 100 shown in FIG. 15, which is displayed on the mobile phone 3 when the user makes a reservation. After receiving the confirmation screen (step S54), the user inputs such items as the ID number, the PIN, and the password, and transmits them back to the reservation control center 1 (step S55).

The reservation control center 1, after receiving the ID number, the PIN, and the password of the user (step S56), checks the ID number, the PIN, and the password by referring to the customer controlling database 14.(step S57). If the results of checking the ID number, the PIN, and the password are no good, or the user cancels the transaction (i.e., NG, CANCEL in step S57 shown in FIG. 1), the reservation control center 1 cuts off the communication (access) (step S58).

Also, if the results of checking the ID number, the PIN, and the password are good (i.e.. OK in step S57 shown in FIG. 11), the process returns to the main routine shown in FIG. 10, and the next reservation acceptance process is carried out.

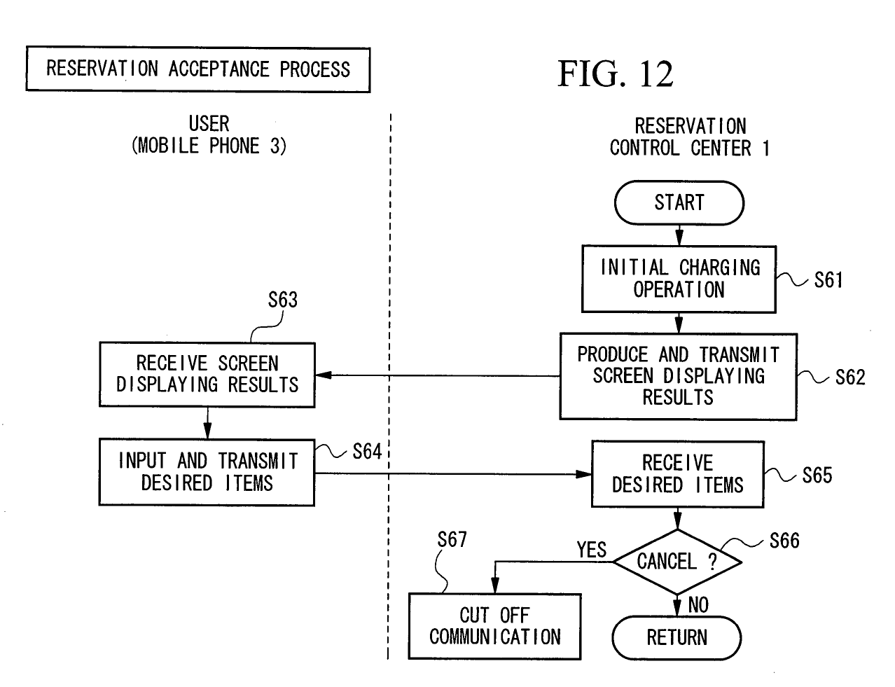

FIG. 12 is a chart showing the reservation procedure for the shared vehicle 2 carried out between the user (mobile phone 3) and the reservation control center 1 including the operations performed by the user. In FIG. 12, the reservation acceptance process, in particular, is described in detail.

After carrying out the authentication process for the access of the user, the reservation control center 1 checks the above-mentioned maldistribution of the shared vehicles 2, and carries out the initial charging operation in which fees for using the shared vehicles 2 are set depending on the moving directions of the vehicles 2 between the ports (step S61).

If the maldistribution of the shared vehicles 2 among the ports is confirmed as a result of the initial charging operation, the reservation control center 1 produces a screen displaying the results and transmits it to the mobile phone 3 (step S62).

An example of the screen showing the results in the reservation acceptance process is shown in FIG. 15 as a rental display screen 101 which may be displayed on the display of the mobile phone 3.

In the rental display screen 101, the display signals indicating the maldistribution of shared vehicles 2 at each port, which are explained above with reference to FIGS. 4A and 4B, may be used as follows:

(1) port ABC: ⊚ indicating an appropriate available number of vehicles;

(2) port DEF: X indicating the occurrence of maldistribution having a greater number of vehicles than the upper limit;

(3) port GHI: ⊚ indicating an appropriate available number of vehicles; and

(4) port JKL: Δ indicating the occurrence of maldistribution having a smaller number of vehicles than the lower limit.

Also, if no vehicle is available for use, it is displayed as “number 0”.

After receiving the screen showing the results as above (step S63), the user inputs such items as the port of departure, the port of arrival, the type of vehicle, expected day and hours of use, and comments, and transmits them back to the reservation control center 1 (step S64).

After receiving the ports of departure and arrival, the type of vehicle, expected day and hours of use, comments, etc., (step S65), the reservation control center 1 determines if the user has cancelled the transaction (step S66). If the user cancels the transaction (i.e., YES in step S66 in FIG. 12), the reservation control center 1 cuts off the communication (access) (step S67).

If the user does not cancel the transaction (i.e., NO in step S66 in FIG. 12), the process returns to the main routine shown in FIG. 10 and carries out the next vehicle deficiency corresponding process.

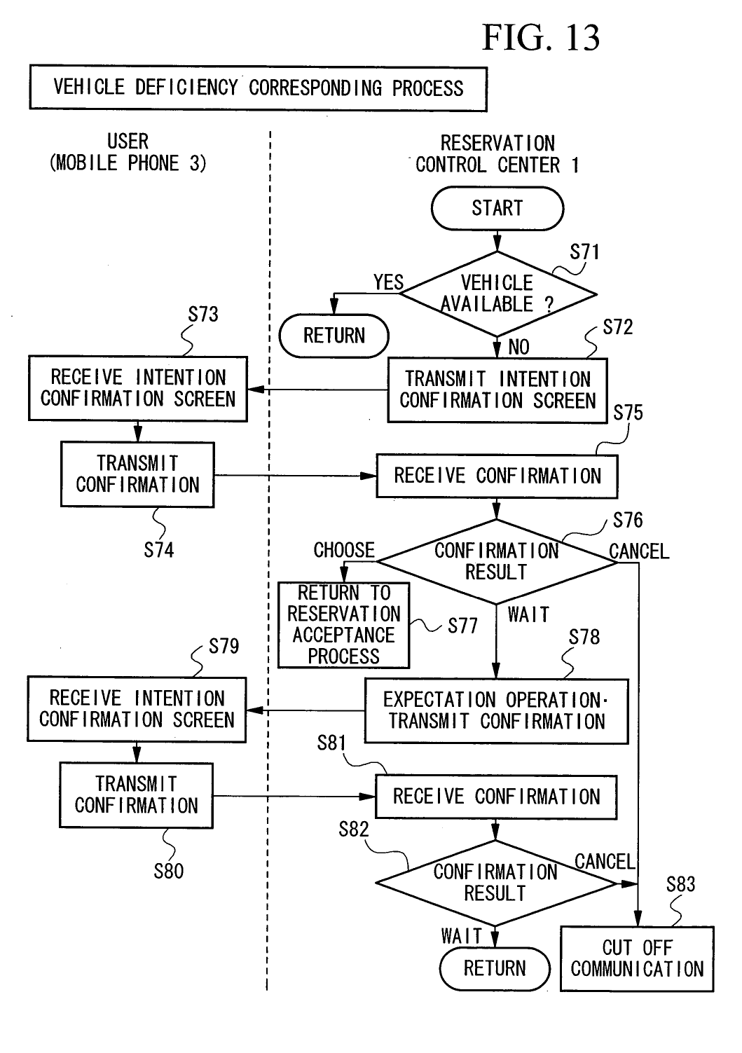

FIG. 13 is a chart showing the reservation procedure for the shared vehicle 2 carried out between the user (mobile phone 3) and the reservation control center 1 including the operations performed by the user. In FIG. 13, the vehicle deficiency corresponding process, in particular, is described in detail.

After receiving the desired use conditions from the user, such as the ports of departure and arrival, the type of vehicle, expected day and hours of use, the reservation control center 1 determines if there is a shared vehicle 2 that satisfies the user's desired use conditions (step S71). If there is a shared vehicle 2 that satisfies the condition (i.e., YES in step S71 in FIG. 13), the process returns to the main routine shown in FIG. 10 and carries out the next reservation confirmation process.

If there is no shared vehicle 2 that satisfies the user's conditions, on the other hand (i.e., NO in step S71 in FIG. 13), the reservation control center 1 transmits a screen to the user through which the user's second intention may be confirmed (step S72).

An example of the screen confirming the intention of a user when no vehicle satisfying the desired use condition is available in the vehicle deficiency corresponding process is shown in FIG. 15 as a confirmation screen A 102 which may be displayed on the display of the mobile phone 3. After receiving the intention confirmation screen (step S73), the user selects one of “Wait”, “Cancel”, and “Choose another” appearing on the display and transmits the selection to the reservation control center 1 (step S74).

After receiving the selection made by the user (step S75), the reservation control center 1 confirms the intention of the user (step S76) and returns to the reservation acceptance process (step S77) if the user selects “Choose another” (i.e., CHOOSE in step S76 in FIG. 13).

Also, if the user selects “Wait” (i.e., WAIT in step S76 in FIG. 13), the reservation control center 1 computes the expected waiting time for the user by operation and transmits another intention confirmation screen which includes the waiting time to the mobile phone 3 (step S78).

An example of the intention confirmation screen displayed while the user is waiting for the available vehicle is shown in FIG. 15 as a confirmation screen B 103 which may be displayed on the display of the mobile phone 3. After receiving the intention confirmation screen (step S79), the user selects one of “Wait”, and “Cancel” and transmits the selection to the reservation control center 1 (step S80).

After receiving the selection made by the user (step S81), the reservation control center 1 confirms the intention of the user (step S82) and returns to the main routine shown in FIG. 10 if the user selects “Wait” (i.e., WAIT in step S82 in FIG. 13) to carry out the next reservation confirmation process.

On the other hand, if the user selects “Cancel” (i.e., CANCEL in step S76 or CANCEL in step S82 in FIG. 13), the reservation control center 1 cuts off the communication (step S83).

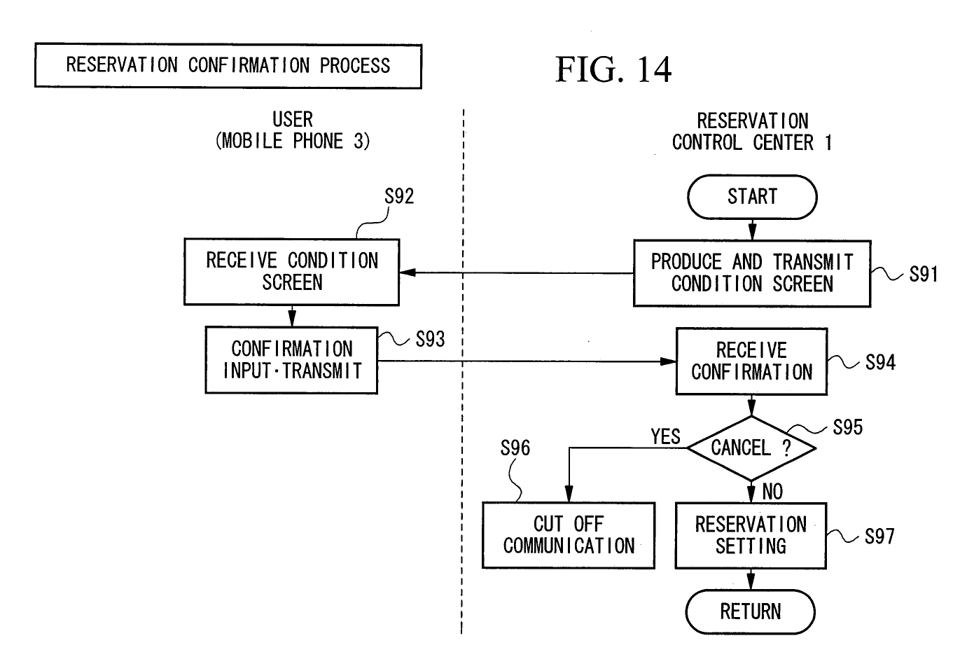

FIG. 14 is a chart showing the reservation procedure for the shared vehicle 2 carried out between the user (mobile phone 3) and the reservation control center 1 including the operations performed by the user. In FIG. 14, the reservation confirmation process, in particular, is described in detail.

The reservation control center 1 transmits to the mobile phone 3 a screen which includes the conditions input by the user in order to confirm the reservation (step S91) if a shared vehicle that satisfies the user's desired use conditions is found as a result of the vehicle deficiency corresponding process, or while the user is waiting for the shared vehicle that satisfies the user's desired conditions become available.

An example of the condition confirmation screen is shown in FIG. 15 as a condition screen 104 which may be displayed on the display of the mobile phone 3. After receiving the condition confirmation screen (step S92), the user confirms the displayed conditions on each item and transmits the confirmation input to the reservation control center 1 (step S93).

After receiving the confirmation input by the user (step S94), the reservation control center 1 determines whether the user has cancelled the transaction (step S95), and if the user has cancelled the transaction (i.e., YES in step S95 in FIG. 14), cuts off the communication (step S96).

Also, if the user has not cancelled the transaction (i.e., NO in step S95 in FIG. 14), the reservation control center 1 carries out the reservation setting process in accordance with the confirmed items (step S97).

Industrial Applicability

As described above, according to the embodiments of the present invention, it becomes possible to resolve the generation of maldistribution of vehicles among the ports without using operations by staff members of the system by ascertaining the maldistribution circumstances of the vehicles among the ports and setting a lower fee for using the vehicles in directions eliminating the maldistribution as well as by notifying the users of the generation of maldistribution at certain ports in order to make the users determine the directions (routes) of the vehicles that can be utilized at lower costs so that the use of the vehicles in such directions is enhanced.

Accordingly, economic advantages may be obtained according to the present invention in the service of providing shared use of vehicles by decreasing the quantity of operations carried out by staff members to increase the efficiency in performing an operation, and by decreasing the number of the staff members required for the service.

Having thus described several exemplary embodiments of the invention, it will be apparent that various alterations, modifications, and improvements will readily occur to those skilled in the art. Such alterations, modifications, and improvements, though not expressly described above, are nonetheless intended and implied to be within the spirit and scope of the invention. Accordingly, the invention is limited and defined only by the following claims and equivalents thereto.

1. A vehicle rental managing unit, which is used in a vehicle rental managing system for managing vehicles to be lent to users by providing a plurality of ports used for parking the vehicles, comprising:
a vehicle excess-deficiency determination unit which determines an excess number or deficient number of the vehicles at each of the ports by accessing rental information of the vehicles at the ports, and
a fee setting unit which sets a fee smaller than a normal fee for a use of the vehicles being lent from a port determined to have an excess number of the vehicles by said vehicle excess-deficiency determination unit, or for a use of the vehicles to be returned to a port determined to have a deficient number of the vehicles by said vehicle excess-deficiency determination unit.

2. A vehicle rental reservation terminal, which is used in a vehicle rental managing system for managing vehicles to be lent to users by providing a plurality of ports used for parking the vehicles, comprising:
a conditions display unit which receives and displays information relating to rental circumstances of the vehicles at each of the ports, and
a port selection unit which makes the users choose a port of use based on the vehicle rental circumstances at each of the ports displayed by said conditions display unit.

3. A vehicle rental reservation terminal according to claim 2, wherein
said conditions display unit displays the information relating to rental circumstances of the vehicles at each of the ports in a manner distinguishing the ports having an excess number or a deficient number of vehicles from the other ports.

4. A vehicle rental managing system for managing vehicles to be lent to users by providing a plurality of ports used for parking the vehicles, comprising:
a vehicle excess-deficiency determination unit which determines an excess number or a deficient number of vehicles at each of the ports by accessing rental circumstances of the vehicles at the ports,
a fee setting unit which sets a fee smaller than a normal fee for a use of the vehicles being lent from a port determined to have an excess number of the vehicles by said vehicle excess-deficiency determination unit, or for a use of the vehicles to be returned to a port determined to have a deficient number of the vehicles by said vehicle excess-deficiency determination unit;
a conditions display unit which displays information relating to rental circumstances of the vehicles at each of the ports, the information being received from said vehicle excess-deficiency determination unit, and
a port selection unit which makes the users choose a port of use based on the vehicle rental circumstances at each of the ports displayed by said conditions display unit.

5. A vehicle rental managing system according to claim 4, wherein
said conditions display unit displays the information relating to rental circumstances of the vehicles at each of the ports in a manner distinguishing the ports having an excess number or a deficient number of the vehicles from the other ports so that the users can determine routes of the vehicles, fees of which are set to be smaller than the normal fees by said fee setting unit.

6. A vehicle rental managing method, which is used in a vehicle rental managing system for managing vehicles to be lent to users by providing a plurality of ports used for parking the vehicles, comprising:
a vehicle excess-deficiency determination step in which an excess number or a deficient number of the vehicles at each of the ports is determined by accessing rental circumstances of the vehicles at the ports;
a fee setting step in which a fee smaller than a normal fee is set for a use of the vehicles being lent from a port determined to have an excess number of the vehicles by said vehicle excess-deficiency determination step, or for a use of the vehicles to be returned to a port determined to have a deficient number of the vehicles in said vehicle excess-deficiency determination step;
a condition display step in which information relating to rental circumstance of the vehicles at each of the ports is displayed, the information being received from said vehicle excess-deficiency determination step;
a port selection acquiring step in which information relating to a port of use selected by the user based on the vehicle rental circumstances displayed in said conditions display step is acquired, and
a vehicle rental step in which a vehicle is lend to the user at the port selected by the user in said port selection acquiring step at the fee determined in said fee setting step.

7. A vehicle rental managing method according to claim 6, wherein
the information relating to rental circumstances of the vehicles at each of the ports is displayed in a manner distinguishing the ports having an excess number or a deficient number of the vehicles from the other ports in said conditions display step so that the users can determine routes of the vehicles, fees of which are set to be smaller than the normal fees by said fee setting step.

8. A vehicle rental managing method according to claim 7, wherein
the information relating to the rental circumstances of the vehicles at each of the ports is displayed on a terminal of the user in said conditions display step, and the information relating to the port of use selected by the user is acquired through the terminal of the user in said port selection acquiring step.

9. A vehicle rental managing method according to claim 7, wherein
the information relating to rental circumstances of the vehicles at each of the ports is displayed on a terminal of the user, the Internet, or a bulletin board provided at the ports in said conditions display step.
